(19) United States
(12) Patent Application Publication
(10) Pub. No.: US 2010/0245064 A1
(43) Pub. Date: Sep. 30, 2010

(54) METHOD AND MEANS FOR PROVIDING SAFETY RELATED MESSAGES TO DRIVERS

(75) Inventors: Hod FLEISHMAN, Jerusalem (IL); Ofer Raz, Moshav Bnaya (IL)

Correspondence Address: BROWDY AND NEIMARK, P.L.L.C.;624 NINTH STREET, NW, SUITE 300, WASHINGTON, DC, 20001-5303, US

(73) Assignee: GREENROAD DRIVING TECHNOLOGIES LTD., Beit-Dagan (IL)

(21) Appl. No.: 12/415,099

(22) Filed: Mar. 31, 2009

(51) Int. Cl. B60Q 1/00; H04Q 1/30

(52) U.S. Cl. 340/425.5; 340/532

(57) ABSTRACT

A system and a method are described for providing one or more messages associated with driving hazards to a driver of a vehicle, comprising: i. providing data derived from more than one driving sessions driven by the driver, and storing data that relate to a plurality of driving events associated with that driver; ii. identifying at least one event that might constitute a potential hazard in future driving sessions of that driver; and iii. sending one or more messages based on the at least one identified event.

### FIELD OF THE INVENTION

The present invention relates to a method and system for presenting information to a driver of a vehicle, and in particular to the provisioning of messages to such a driver of a vehicle.

### BACKGROUND OF THE INVENTION

Car accidents have long become the number one cause for casualties in western countries. Putting aside the human life issue for which no price tag can be associated, the economical damage caused by traffic accidents and other additional expenses is estimated by millions and millions of dollars every year. Most of the car accidents cannot be attributed to one element but rather to a combination of several, for example: the driver performance as well as the driver physical condition (tiredness, alcohol influence etc.), environmental conditions, roads' maintenance level, other vehicles behavior on the road, hence the complicity in overcoming this problem of ever growing epidemic of car accidents.

In many countries it is customary that before a new driver (usually a teenage driver) is legally permitted to drive on its own, he/she has to pass a supervision period with a responsible adult (usually the parents). There are many scenarios that the parents of the teenage driver cannot fulfill their role as a tutor and supervisor, and there are many cases that the teenage drivers need extra learning time. Only the supervisor is able to determine whether or not the teenager is ready to drive without adult supervision. A big portion of car accidents is caused by inexperience drivers and drivers with bad driving habits, both causes can be easily overcome with the right coaching and supervision.

Many systems trying to cope with the problem of car accidents in various ways, most of them rely on having some sensors within the vehicle, capable of monitoring the state and the location of the vehicle and provide indications/alerts if the vehicle enters a risky situation usually based on one or more thresholds.

For example U.S. Pat. No. 5,570,087 discloses a system and method for monitoring the performance of a vehicle. The vehicle's instantaneous accelerations are continually sensed and stored as coded signals in a computer memory. Performance variables of the vehicle are computed from the acceleration signals and stored in a memory along with associated time and date codes. By means of inertial navigation and/or GPS the vehicle's location is also computed and stored. The stored performance variables are analyzed over a period of time and when an erratic or otherwise hazardous driving pattern is detected, signals may be generated to warn the driver and/or traffic authorities.

U.S. Pat. No. 5,270,708 discloses a system that detects a vehicle's position and orientation, turning, and speed, and coupled with a database of past accidents at the present location and determines whether the present vehicle's driving conditions are similar to those of a past accident, and if so, alerts the driver. For example, if the current vehicle speed on a particular road exceeds the speed threshold previously stored in the database at that point of the road, the driver is alerted.

U.S. Pat. No. 7,389,178 and U.S. 2007001831 which are hereby incorporated by reference in their entirety, disclose methods and systems for evaluating a driver performance and for displaying it, respectively. The methods and systems described are based on a vehicle sensor utility that produces a raw data stream that is input to a driving event handler which detects driving events in the raw data stream and outputs a driving event string to a maneuver detector. The maneuver detector is configured to recognize patterns of driving maneuvers. The driver's driving performance is then rated based upon the driving maneuvers as executed by the driver. The ratings are displayed in a real time manner.

Unfortunately, all the methods and systems known in the art do not provide an adequate solution to the current situation, and there is a great need in today's reality to help the struggle in car accidents. The present invention seeks to help in this struggle and provides a new approach to the prevention of car accidents.

### SUMMARY OF THE INVENTION

It is an object of the present invention to provide a method and a system for providing a user with a coaching experience regarding future driving-related decisions, through the provisioning of messages to that user.

It is another object of the present to provide a method and a system that keeps record of the driver performance and uses a plurality of data sources to acquire a complete picture on the driver's way of driving.

It is another object of the present invention to provide a method and a system that is based upon past events that is capable of warning the driver before a hazardous driving session or a hazardous driving event is about to take place.

It is another object of the present invention to provide a method and a system that controls the information the user receives regarding the driver's way of driving in order to obtain the maximum effect of the solution provided.

Other objects of the invention will become apparent as the description of the invention proceeds.

Thus, according to a first embodiment of the present invention there is provided a method for providing one or more messages (preferably personalized messages) associated with driving hazards to a driver of a vehicle, comprising:
i. providing data derived from more than one driving sessions driven by said driver, and storing data that relates to a plurality of driving events associated with said driver;
ii. identifying at least one event that might constitute a potential hazard in future driving sessions of said driver;
iii. sending one or more messages based on said at least one identified event.

The term “personalized message” as used herein through the specification and claims should be understood to encompass messages which the user receives and understands their relevancy to the specific driver who is monitored, irrespective if that message was generated particularly for that user, or is a one of the users who receives a message that is being broadcasted to a plurality of users, as it will contain elements that are characteristics of that driver (as well as of the other drivers who receive that broadcasted message).

According to another embodiment of the present invention the data provided in step (i) for at least one of the driving session is derived from a plurality of sources, wherein at least one of said plurality of sources is a real-time data source wherein at least one of those sources is a real-time data source (e.g. GPS, a hardware installed at the vehicle and provides data related to the driving performance) and at least one is an off-line data source (e.g. meteorological station, demographic questionnaire, updated roads map, calendar dates etc.). Since the amount of data collected every driving session is very big and varied, a stored driving event may be compressed by storing values of some certain characteristics features

According to another embodiment of the invention the one or more messages relate to a current driving session being executed by the driver. For example if the driver is driving a road he drove before, and along the road there is a sharp curve which the driver entered too fast already three times before when driving at night, by using the real-time data to identify that the driver is driving along that road and the fact that he drives at night, taken together with data related to his past performance at that curve, a determination is made that there is a hazard ahead of the driver, and the driver will get a message to alert him well before the curve, of the dangerous curve that is ahead.

According to another preferred embodiment of the present invention the one or more messages are derived from comparing at least one event in the current driving session with stored events.

In accordance to another embodiment of the present invention step (iii) further comprising a step of determining prior to sending the one or more messages, at least one member of the group consisting of: which of the at least one identified event should be reported in said one or more messages, when should said one or more messages be sent, the form in which said one or more messages would be delivered and the form in which said one or more messages would be presented.

According to yet another embodiment of the present invention the one or more messages which relate to at least one event that might constitute a potential hazard in future driving sessions is presented at an Internet site or on a display means located in the driver's vehicle. In that way the driver may receive warning messages before starting a driving session or even after having started a driving session. In addition, the driver (or his superior) may review the progress of his driving based on the messages received, where the messages are preferably accessible only to authorized people.

According to another embodiment of the present invention the one or more messages is being sent to at least one person other than said driver (e.g. in case the driver is a teenager some messages maybe delivered to his parents).

In accordance with another embodiment of the invention, a message may be sent, preferably simultaneously, to a group of people. Such one or more messages (which would preferably be perceived by each of its recipients as a personalized messages) may be sent for example to a group of people having a common demographic characteristics (e.g. in a prom night all the drivers registered in the system of the right age range would receive an SMS advising them to drive carefully), or, by another example, to a group of people having similar performance of at least one driving event that presents a potential hazard. The message could be the same to each of the members of this group but in view of its contents it will be perceived as a personalized message, or in the alternative, the contents may be common to all recipients but certain additions such as the recipient's name, etc. could turn such messages into more personalized messages.

According to still another embodiment of the present invention, in a case where a plurality of drivers use the vehicle, the method further comprising a step of identifying the driver out of the plurality of drivers once the driver enters a personalized code prior to collecting new data associated with a current driving session or a driving session that is about to begin, and/or by comparing events from a current driving session to stored events that are associated with each of the plurality of drivers.

According to another aspect of the present invention there is provided a system operative to provide to a plurality of drivers, messages (preferably personalized messages) associated with driving hazards, and wherein the system comprising:
(a) a database for storing data associated with a plurality of driving sessions executed by a plurality of drivers, wherein the data is derived from a plurality of sources, and wherein at least one of the plurality of sources is a real-time data source and at least one of the sources is an off-line data source;
(b) a processor adapted to identify for each of the plurality of drivers, at least one event that might constitute a potential hazard in future driving sessions of the respective driver; and
(c) a delivering means capable of sending one or more messages associated with each of the plurality of drivers and based upon the at least one identified event.

By yet another preferred embodiment, the one or more messages sent by the delivering means are related to a current driving session executed by the driver.

According to another embodiment of the invention, the one or more messages are derived from comparing at least one event in said current driving session with events stored at said database.

In accordance with still another preferred embodiment the processor is further adapted to determine at least one member of the group consisting of: which of the at least one identified event should be reported in the one or more messages to each of the plurality of drivers, when should the one or more messages be sent to each of the plurality of drivers, the form in which the one or more messages would be delivered and the form in which the one or more messages would be presented.

According to yet embodiment, the delivering means adapted to send said one or more messages to at least one person other than said respective driver.

By still another preferred embodiment the delivering means is operative to send one or more messages to a group of people, and wherein each of the group members would receive the same one or more messages.

In accordance with another aspect of the present invention, there is provided a computer program product comprising a computer useable medium having computer readable program code embodied therein for providing one or more personalized messages associated with driving hazards to a driver of a vehicle, the computer program product comprising: computer readable program code for causing an apparatus to receive data derived from more than one driving sessions driven by said driver, and to store data that relates to a plurality of driving events associated with said driver; computer readable program code for causing said apparatus to identify at least one event that might constitute a potential hazard in future driving sessions of said driver; and computer readable program code for causing said apparatus to send one or more messages based on said at least one identified event.

Preferably, the computer program is embodied on a computer readable medium.

### BRIEF DESCRIPTION OF THE DRAWINGS

For a more complete understanding of the present invention, reference is made to the following detailed description taken in conjunction with the accompanying drawings wherein:

FIG. 1—presents the steps of a method according to an embodiment of the present invention;

FIG. 2—presents an example demonstrating an example of carrying out an embodiment of the present invention; and

FIG. 3—illustrates a schematic overview on the system architecture.

### DETAILED DESCRIPTION OF THE INVENTION

The principles and operation of the method and system according to the present invention may be better understood with reference to the accompanying drawings and the following description that illustrate some specific non-limiting examples of preferred embodiments.

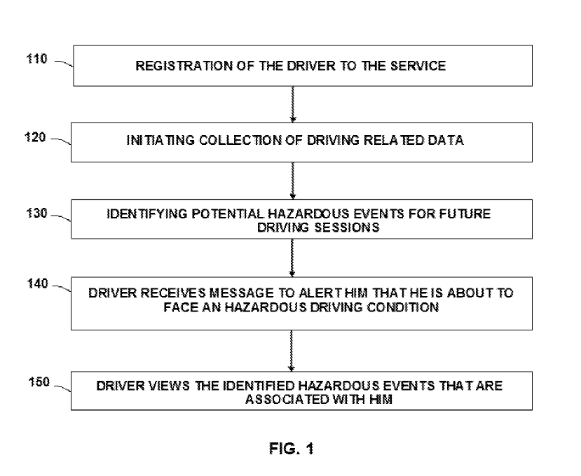

FIG. 1 is a flow chart demonstrating the steps of a method according to an embodiment of the present invention, where in this example the driver belongs to a company having a fleet of vehicles. Step 110 is a registration step in which the driver, who joins the service, has a data collecting system installed in his/her vehicle and fills a questionnaire that allows recovering certain demographic data about each driver, his/her parents, families and groups to which he/she may belong. In addition, the driver may express his/her preference of the frequency of receiving messages, the preferred form of delivering the messages, etc. Once the driver has completed the registering step, a data collecting step is initiated (120). In this step, as soon as the driver starts using his vehicle, events that are associated with his/her driving performance are collected and are preferably gathered in respective driving sessions. A driving session may be defined as a period of time from the moment that the driver starts using the car till the time he turns it off. In every such driving session, data is preferably retrieved from a plurality of data sources and stored at a database in the service provider's server. The data sources may be divided into real-time data sources and off-line data sources. The main real-time data source is the system installed in the driver's car which comprises several sensors, and produces a data stream that indicates the driving performance in that session. An example of such a system is provided in the Applicant's U.S. Pat. No. 7,389,178, one which is capable of indicating how well each maneuver that was taken by the driver was executed. Apart from the data that relates to the driver's driving performance, a GPS is used to retrieve data regarding his course and the car's exact location every second so that the various events that occurred during the driving may be associated with the exact location at which they took place. Some of the off-line data sources provide data on any one of the following: traffic condition, weather condition, road type and condition, driving zones, special dates, and any combination thereof. Using all these data sources, enable to obtain a complete picture regarding each driving session and all or representative events may be stored in the database.

In step 130, the events that might constitute a potential hazard for future driving sessions or in the near future (including potential danger in the current driving session) are identified. For example, if the driver comes back from work every evening but in those days when he stays later at work, he tends to cross lanes dangerously, the system correlates the events that the driver stays late at work and that he drove recklessly, so that at the next time that the driver stays late at work, before starting his way home, the driver will receive a message (step 140), advising him to exercise great care when driving back home especially while crossing lanes. The message can be in any one of following forms: SMS, MMS, e-mail, web application (or even in hard-copy mail if time allows using this option). In the alternative, the message may also be presented on the display located in the driver's car enabling the driver to view a message generated either by the system installed in the car or at the service provider's server. Although, in the above described example, the personalized message was preferably sent to the driver, still there are cases whether the message should not necessarily be addressed to the driver, but it can for example be address to the driver's parent, employee, wife etc., for example if the driver is a youngster and the system has identifies that during night time his driving performance deteriorates, the personalized message may be sent to the driver's parent before the evenings, reminding him to make sure the driver is aware that his driving performance is likely to be worse that in the next hours, and to exercise extra caution if indeed he intends to drive. The personalized message preferably comprises content related to the identified events i.e. context based coaching.

The last step (step 150) of this example is an optional step by which the driver may access a website at the internet to view all the identified events so that the driver may check up on his own improvement with time.

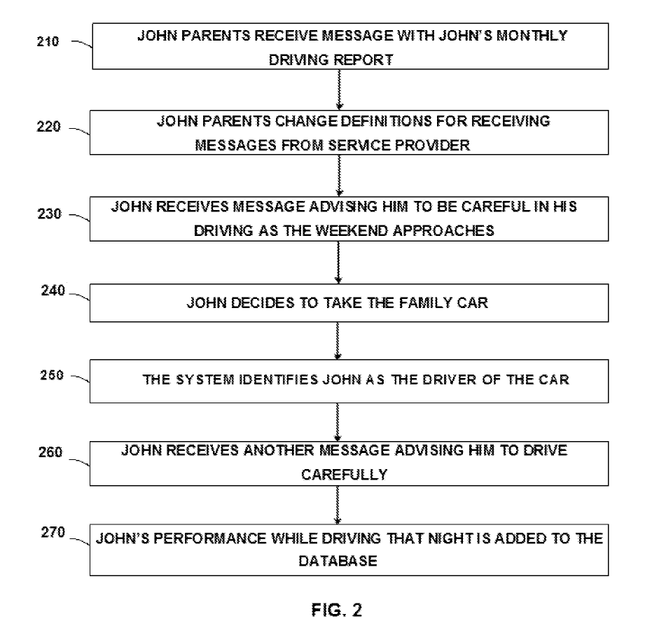

The flowchart illustrated in FIG. 2 is an example that demonstrates the usefulness of the present invention, when dealing particularly with inexperience drivers, as the present invention provides a coaching tool for improving the drivers' abilities and building safe driving norms. Let us assume that on Thursday 14:00. John's parents received an e-mail message containing John's monthly report on his driving performance (step 210). They noted that he improved his daily driving and reduced the number of risky lane passing but when driving in the weekend's nights his driving is careless and there is a probability that he has been driving in certain occasions under the influence of alcohol. Following the receipt of this message, John's parents decided to be more involved, so that in Thursday 16:05 they entered the service provider's website and changed the messaging settings in a way to allow them to be informed as soon as John repeats such poor driving performance on weekend nights (step 220). Friday 17:00 John received an SMS recommending him to take extra caution if he intends to drive that night since the last three times he took the car on Friday evening, his driving was dangerous and he almost had an accident (230). Friday 22:00 John decided to take the family car (step 240). Friday 22:15 the system identified after comparing the partial driving session (i.e. the first 5 minutes thereof) to prior driving sessions of both John's parents and of John himself, that the driving patterns are characteristics of John's weekend's night driving (step 250). Friday 22:16 John received an SMS telling him to drive carefully and to stay away from alcohol (step 260). Next, the driving performance of John was added to the database and his parents received the next Monday a message informing them whether John has improved his driving during that last weekend night (step 270).

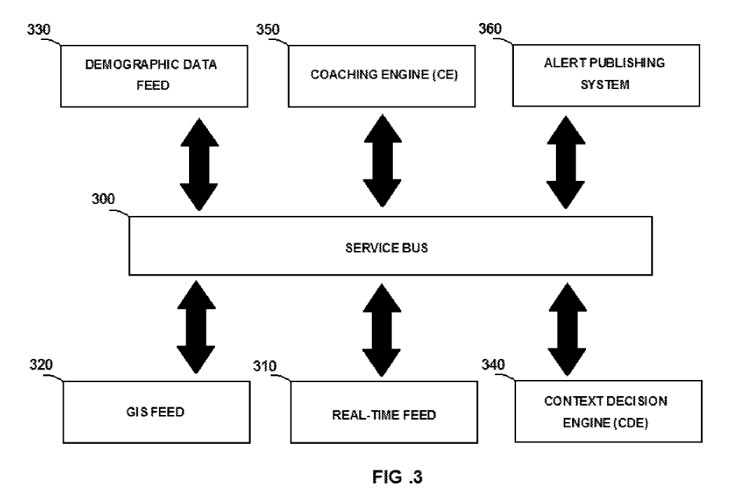

FIG. 3 is a schematic overview of the architecture of a system according to the present invention. The system comprises a service bus (300) that enables all sub systems to exchange and share data between each other by using distribution/subscription design pattern. For example, events that are generated during the driving sessions are retrieved as real time inputs to the system, while the Context Decision Engine (CDE) is subscribed to these events to utilize them as input for the decision to be taken.

The service bus serves as a message broker between (internal and/or external) applications. By serving as an abstraction layer, such an approach reduces the number of point-to-point connections required to allow the applications to inter-communicate.

The first sub system is the Real-Time input unit (310) which is responsible for collecting unsafe events preformed by the drivers and convey this data onto the service bus. This input is derived from the units installed at the end-user vehicles and operate by using several types of sensors. The output of these sensors enables detection of unsafe driving maneuvers preformed on the road.

The second sub system is the GIS input 320. This Geospatial data layer is operative by providing the system with the current location of each vehicle as well as with associated GEO aware events. Such GEO aware events may include: traffic condition, weather condition, road condition and type, driving zones, schools/hospitals located at the car vicinity and more. This data is incorporated with the data retrieved from the car and used by the Context Decision Engine (CDE) to build alerts. Next, another sub-system is the Demographic data input. By a non-limiting example of such sub-system demographic data may be acquired by using information retrieved from a questionnaire that the driver is required to fill when joining the service. This sub-system incorporates in the system all demographic data available about the drivers, their parents, families and groups of people to which they belong. The data that is inputted by this sub-system is also used by the Context Decision Engine (CDE) to construct the alerting messages.

Another sub-system is the Context Decision Engine (CDE) 340. The CDE is an AI application that generates events based on processing data retrieved from multiple sources. As the nature of the data is deferent, some is demographic, some is a real-time driving unsafe events while other is GEO data, it applies several methods (e.g. algorithms) in order to recognize patterns and draw decisions based thereon. While decision trees and neural networks are used in order to recognize patterns within the available data, fuzzy logic algorithms are used to classify the data and decide whether an event should be declared as an event that would lead to the generation of a message based on that data. This is preferably a real time application as some of the event types that are declared as message generating events may require a real time generation of messages by Coaching Engine (CE), 350.

Coaching Engine (CE) 350, is a rule flow driven engine that is responsible to capture the events generated by CDE 340 and process it in the coaching flow context. The CE then determines whether an event outputted by the CDE should be packed with content and sent to the respective client, based on the course of that client's coaching. One of the problems which might render the system non-effective is if the client is flooded with messages (whether they are similar messages or different), so that eventually he would stop paying attention to the messages that will be received. Therefore, the CE is responsible for the coaching flow. The coaching flow is based on predefined rules and flows of coaching paths both for drivers and others (e.g. parents), and each event outputted by the CDE would be evaluated in the context of the coaching flow established. In case the CE determines that a message is to be generated based on a specific event, it is packed with the relevant coaching content and sent to the end used in the defined channel using the Alert Publishing System.

Yet another sub-system is the Alert Publishing System 360, which is responsible to deliver messages to the end user in any one or more of a verity of methods. It can be done by using SMS, MMS, e-mails, web application or hard-copy mail. This sub-system provides a channel to the end user, based on pre-defined agreement therewith.

Thus, the system is able to use data streams describing the driver initiated risks taken together with environmental risks (and preferably demographic data) to establish driver's specific risks, then to identify content topics based on certain events and generate versions of applicable content for the various communication channels. Next, to match the drivers' risks with appropriate content and convey the right content to the right person while using the best communication tool at the right time.

It is to be understood that the above description only includes some embodiments of the invention and serves for its illustration. Numerous other ways of carrying out the methods provided by the present invention may be devised by a person skilled in the art without departing from the scope of the invention, and are thus encompassed by the present invention.

1. A method for providing one or more messages associated with driving hazards to a driver of a vehicle, comprising:
i. providing data derived from more than one driving sessions driven by said driver, and storing data that relate to a plurality of driving events associated with said driver;
ii. identifying at least one event that might constitute a potential hazard in future driving sessions of said driver; and
iii. sending one or more messages based on said at least one identified event.

2. A method according to claim 1, wherein the data provided in step (i) for at least one of the driving session is derived from a plurality of sources, wherein at least one of said plurality of sources is a real-time data source and at least one is an off-line data source.

3. A method according to claim 2, wherein said one or more messages relate to a current driving session being executed by said driver.

4. A method according to claim 3, wherein said one or more messages are derived from comparing at least one event in said current driving session with stored events.

5. A method according to claim 1, wherein step (iii) further comprising a step of determining prior to sending the one or more messages, at least one member of the group consisting of: which of said at least one identified event should be reported in said one or more messages, when should said one or more messages be sent, the form in which said one or more messages would be delivered and the form in which said one or more messages would be presented.

6. A method according to claim 1, wherein the one or more messages which relate to at least one event that might constitute a potential hazard in future driving sessions is presented at an Internet site or on a display means located in the driver's vehicle.

7. A method according to claim 1, wherein said one or more messages is being sent to at least one person other than said driver.

8. A method according to claim 1, wherein said one or more messages is sent simultaneously to a group of people.

9. A method according to claim 1, wherein in a case where a plurality of drivers use said vehicle, the method further comprising a step of identifying said driver out of said plurality of drivers once the driver enters a personalized code prior to collecting new data associated with a current driving session or a driving session that is about to begin, and/or by comparing events from a current driving session to stored events that are associated with each of said plurality of drivers.

10. A system operative to provide to a plurality of drivers, messages associated with driving hazards, and wherein said system comprising:
(a) a database for storing data associated with a plurality of driving sessions executed by a plurality of drivers, wherein said data is derived from a plurality of sources, and wherein at least one of the plurality of sources is a real-time data source and at least one of the sources is an off-line data source;
(b) a processor adapted to identify for each of said plurality of drivers, at least one event that might constitute a potential hazard in future driving sessions of said respective driver; and
(c) a delivering means capable of sending one or more messages associated with each of said plurality of drivers and based upon said at least one identified event.

11. A system according to claim 10, wherein said one or more messages sent by said delivering means are related to a current driving session executed by said driver.

12. A system according to claim 11, wherein said one or more messages are derived from comparing at least one event in said current driving session with events stored at said database.

13. A system according to claim 10, wherein said processor further adapted to determine at least one member of the group consisting of: which of said at least one identified event should be reported in said one or more messages to each of the plurality of drivers, when should said one or more messages be sent to each of said plurality of drivers, the form in which said one or more messages would be delivered and the form in which said one or more messages would be presented.

14. A system according to claim 10, wherein said delivering means adapted to send said one or more messages to at least one person other than said respective driver.

15. A system according to claim 10, wherein said delivering means is operative to send one or more messages to a group of people, and wherein each of the group members would receive the same one or more messages.

16. A computer program product comprising a computer useable medium having computer readable program code embodied therein for providing one or more personalized messages associated with driving hazards to a driver of a vehicle, the computer program product comprising: computer readable program code for causing an apparatus to receive data derived from more than one driving sessions driven by said driver, and to store data that relates to a plurality of driving events associated with said driver; computer readable program code for causing said apparatus to identify at least one event that might constitute a potential hazard in future driving sessions of said driver; and computer readable program code for causing said apparatus to send one or more messages based on said at least one identified event.

17. A computer program as claimed in claim 16 embodied on a computer readable medium.
